(19) United States
(12) Patent Application Publication
(10) Pub. No.: US 2015/0064946 A1
(43) Pub. Date: Mar. 5, 2015

(54) RADIO FREQUENCY SUBSCRIBER DROP EQUIPMENT HAVING HIGH VOLTAGE PROTECTION CIRCUITS AND RELATED CONTACT ASSEMBLIES

(71) Applicant: CommScope, Inc. of North Carolina, Hickory, NC (US)

(72) Inventors: ROBERT E. DARROW, Raleigh, NC (US); Shi Man Li, Mooresville, NC (US)

(21) Appl. No.: 14/471,165

(22) Filed: Aug. 28, 2014

Related U.S. Application Data
(60) Provisional application No. 61/871,925, filed on Aug. 30, 2013.

(51) Int. Cl. H01T 4/04; H01R 13/53; H01T 4/02

(52) U.S. Cl. CPC H01T 4/04; H01T 4/02; H01R 13/53
USPC 439/183

(57) ABSTRACT

RF subscriber drop units have a housing that has a port aperture therethrough and a connector port that extends outwardly from the housing and surrounds the port aperture. The connector port includes a contact assembly that holds a spring contact, the spring contact including a contact tail that extends through the port aperture. A conductive spark gap unit that has a spark gap aperture is further provided and arranged so that the contact tail extends through the spark gap aperture.

### CROSS-REFERENCE TO RELATED APPLICATION

The present application claims priority under 35 U.S.C. §119 to U.S. Provisional Application Ser. No. 61/871,925, filed Aug. 30, 2013, the entire content of which is incorporated by reference herein.

### FIELD OF THE INVENTION

The present invention relates to cable television networks and, more particularly, to radio frequency (“RF”) subscriber drop equipment that is suitable for use in cable television networks.

### BACKGROUND

A coaxial cable is a known type of communications cable that may be used to carry radio frequency (“RF”) signals. Coaxial cables are widely used as transmission lines in cable television networks that provide cable television service, broadband Internet connectivity and Voice-over-Internet Protocol (“VoIP”) telephone service to a plurality of subscribers. Coaxial cables are also used in a wide variety of other applications such as, for example, interconnecting electrical equipment, connecting electrical equipment to antennas and various other applications. FIG. 1 is a perspective view of a conventional coaxial cable 10 that has been partially cut apart to reveal its internal structure. As shown in FIG. 1, the coaxial cable 10 has a central conductor 12 that is surrounded by a dielectric insulator 14. A tape 16 may be bonded to the outside surface of the dielectric insulator 14. A metallic electrical shield 18 such as braided shielding wires surrounds the central conductor 12, dielectric insulator 14 and tape 16. One or more electrical shielding tapes (not shown in FIG. 1) may surround the metallic electrical shield 18. The central conductor 12, dielectric insulator 14, tape 16, electrical shield 18 and any electrical shielding tape are enclosed within a protective cable jacket 20.

The central conductor 12 of coaxial cable 10 may comprise, for example, a copper wire or a copper clad aluminum or steel wire. The central conductor 12 is designed to carry RF signals. Typically, a conductor such as central conductor 12 that carries RF or other high frequency signals acts as an antenna, and thus some of the signal energy is radiated from the conductor, resulting in signal loss or “attenuation.” Coaxial cables are designed to reduce such signal attenuation by positioning the electrical shield 18 (which is connected to a ground reference) around the central conductor 12. As a result of this arrangement, the electromagnetic field of the RF signal that is carried by the central conductor 12 is generally trapped in the space inside the electrical shield 18, thereby greatly reducing signal radiation and associated signal attenuation losses.

Typically, each end of a coaxial cable is terminated with a male coaxial connector. The most common type of coaxial connectors are referred to in the art as “F-style” coaxial connectors. Female F-style coaxial connectors, which are often referred to as “connector ports” are commonly mounted on wall plates in homes and on various devices such as televisions, cable modems, splitters, signal amplifiers, tap units, ground blocks, etc. A typical female F-style connector port comprises an externally threaded cylindrical housing that includes an aperture on one end thereof that is configured to receive a protruding central conductor of a male F-style coaxial connector. A typical male F-style coaxial connector includes an internally-threaded nut which is threaded onto the externally-threaded housing of the female F-style coaxial connector port. A coaxial cable that includes a coaxial connector on at least one end thereof is referred to herein as a “terminated coaxial cable.” Terminated coaxial cables are used in a wide variety of applications including use as jumper cables, internal cabling within buildings, drop cables and the like.

FIG. 2 is a perspective view of a conventional male F-style coaxial connector 30. FIG. 3 is a side cross-sectional view of the male F-style coaxial connector 30 of FIG. 2. FIG. 4 illustrates the connector 30 of FIGS. 2-3 after it has been attached to an end of a coaxial cable 10 to produce a terminated coaxial cable.

As shown in FIGS. 2-4, the F-style coaxial connector 30 includes a tubular connector body 32, a contact post 34, a compression sleeve 36 and an internally-threaded nut 38. In FIG. 2, the compression sleeve 36 is depicted in its “unseated” position in which it may receive a coaxial cable 10 that is to be terminated into the coaxial connector 30.

When the compression sleeve 36 of coaxial connector 30 is in its unseated position of FIG. 2, a coaxial cable such as cable 10 may be inserted axially into the compression sleeve 36 and the connector body 32. The central conductor 12, dielectric insulator 14 and tape 16 of cable 10 (the coaxial cable 10 is not depicted in FIGS. 2-3 to more clearly show the structure of the connector 30) are inserted axially into the inside diameter of the contact post 34, while the electrical shield 18, and the cable jacket 20 are inserted inside the tubular connector body 32 so as to circumferentially surround the outer surface of the contact post 34. The outside surface of the contact post 34 may include one or more serrations, teeth, lips or other retention structures 35 (see FIG. 3). Once the coaxial cable 10 is inserted into the coaxial connector 30 as described above, a compression tool may be used to forcibly axially insert the compression sleeve 36 further into the tubular connector body 32 into its “seated” position (see FIG. 4). Moving the compression sleeve 36 into its seated position decreases the radial gap between the tubular connector body 32 and the contact post 34 so as to radially impart a generally 360-degree circumferential compression force on the electrical shield 18 and the cable jacket 20 that circumferentially surround the outer surface of contact post 34. This compression, in conjunction with the retention structures 35 on the outside surface of the contact post 34, applies a retention force to the coaxial cable 10 that firmly holds the coaxial cable 10 within the coaxial connector 30. As shown in FIG. 4, the central conductor 12 of the coaxial cable 10 extends into the internal cavity of the internally-threaded nut 38 to serve as the male protrusion of the coaxial connector 30.

As noted above, male F-style coaxial connectors such as connector 30 are used to mechanically and electrically attach a coaxial cable such as coaxial cable 10 to a female connector port. A wide variety of RF subscriber drop units such as splitters and directional couplers, signal amplifiers, tap units, inline filters and the like include female connector ports and are connected to other RF subscriber drop units via coaxial cables that have F-style coaxial connectors on either end thereof. For example, a 1×2 RF splitter has a first female connector port that acts as an input port and second and third female connector ports that act as first and second output ports. First through third coaxial cables, each of which is terminated with an F-style coaxial connector, may be connected to the respective first through third female connector ports. Electronic circuit elements are typically mounted on a printed circuit board within the RF splitter to divide the signals input through the input port and deliver the splits signals to the output ports. FIG. 5 is a perspective view of a conventional F-style female connector port 40 that is widely used on RF splitters, ground blocks, amplifiers, and the like. FIG. 6 illustrates a conventional coaxial cable splitter 50 having the female connector ports 40 of FIG. 5.

As shown in FIG. 5, the female connector port 40 may comprise a cylindrical housing 41 that has a plurality of external threads 42. The distal face 44 of the cylindrical housing 41 includes an aperture 46. A central conductor 48 (barely visible in FIG. 5) runs longitudinally through the center of the female connector port 40. The internally-threaded nut 38 of a mating male F-style coaxial connector 30 is inserted over, and threaded onto, the external threads 42 of the female connector port 40 so that the central conductor 12 of the coaxial cable 10 that is attached to the coaxial connector 30 is received within the aperture 46. The central conductor 48 of female connector port 40 is configured to receive the central conductor 12 of the mating male F-style coaxial connector 30, thereby electrically connecting the central conductors 12, 48. Once the internally-threaded nut 38 is fully threaded onto the external threads 42 of the female connector port 40, the distal face 44 of the female connector port 40 is brought into mechanical and electrical contact with the base 34b (FIG. 3) of the contact post 34, thereby providing a ground plane connection between the body assembly 32 of coaxial connector 30 and the housing 41 of the female connector port 40.

When summoned to fix a problem with a cable television subscriber's service, technicians may not take the time to trouble-shoot various connections associated with a drop. Instead, the technicians may cut the F-style coaxial connectors off of the coaxial cables and throw away any splitters, couplers, or other devices. Unfortunately, this practice increases costs to cable television service providers. Moreover, this practice is wasteful in many cases because otherwise good connectors and/or devices are being thrown away. Additionally, RF subscriber drop units may be subject to damage from high transient voltages that may be passed from the coaxial cables into the RF subscriber drop units.

### BRIEF DESCRIPTION OF THE DRAWINGS

The accompanying drawings illustrate various embodiments of the present invention. The drawings and description together serve to fully explain embodiments of the present invention.

FIG. 1 is a perspective view of a conventional coaxial cable that has been partially cut apart.

FIG. 2 is a perspective view of a conventional male F-style coaxial connector that has a compression style back fitting with the compression sleeve thereof in an unseated position.

FIG. 3 is a longitudinal cross-sectional view of the conventional F-style coaxial connector of FIG. 2.

FIG. 4 is a perspective view of the conventional F-style coaxial connector of FIG. 2 mounted on a coaxial cable to provide a terminated coaxial cable.

FIG. 5 is a perspective view of a conventional female connector port.

FIG. 6 is a perspective view of a conventional 1×2 RF splitter that utilizes the female connector ports of FIG. 5.

FIG. 7A is a partially-exploded perspective view of an RF subscriber drop unit according to embodiments of the present invention with the cover thereof removed.

FIG. 7B is a bottom, partially-exploded view of the RF subscriber drop unit of FIG. 7A.

FIG. 7C is a side, partially-exploded view of the RF subscriber drop unit of FIG. 7A.

FIG. 7D is a cross-sectional view taken along the line 7D-7D of FIG. 7C.

FIG. 7E is an enlarged view of the callout labeled “B” in FIG. 7D.

FIG. 7F is an enlarged view of the callout labeled “C” in FIG. 7A.

FIG. 8A is a perspective view of a contact assembly that is included in the connector ports of the RF subscriber drop unit of FIGS. 7A-7F.

FIG. 8B is a bottom view of the contact assembly of FIG. 8A.

FIG. 8C is a side view of the contact assembly of FIG. 8A.

FIG. 8D is a side, cross-sectional view taken along the line 8D-8D of FIG. 8C.

FIG. 8E is an exploded perspective view of the contact assembly of FIG. 8A.

FIG. 8F is an exploded, cross-sectional view of the contact assembly of FIG. 8A.

FIG. 9 is an enlarged, bottom view illustrating the contact tail of the contact assembly of FIG. 8A extending through the aperture in the conductive spark gap unit included in the contact assembly.

FIG. 10 is a section view of the RF subscriber drop unit of FIGS. 7-8 illustrating how a coaxial cable may be terminated into one of the connector ports thereof.

### DETAILED DESCRIPTION

Pursuant to embodiments of the present invention, RF subscriber drop equipment such as RF splitters, directional couplers, tap units, signal amplifiers, inline filters and the like are provided that have connector ports that each have conductive spark gap units that surround the contact tail of a spring contact structure of the connector port. In some embodiments, the spring contact may be mounted in a contact assembly. The contact tail may comprise a flat strip of conductive material. The conductive spark gap unit has an opening therethrough. The contact tail may be inserted through the opening in the conductive spark gap unit so that edges of the contact tail are in close proximity to the edge(s) of the conductive spark gap unit that define the opening therethrough. When a sufficiently high voltage is imparted to the spring contact, current may arc from the contact tail to an edge of the conductive spark gap unit that is in close proximity to the contact tail. The spark gap ring may be electrically connected to a grounded housing of the RF subscriber drop unit and may therefore discharge the high voltage to ground.

In some embodiments, the conductive spark gap unit may include a hollowed-out protrusion. The opening through the conductive spark gap unit may be at the bottom of the protrusion. A moisture seal such as, for example, an insulative disk that has an aperture therethrough may extend through the hollowed-out protrusion of the conductive spark gap unit. The contact tail may be inserted through the aperture in the moisture seal. The aperture through the moisture seal may have a cross-section that substantially matches a cross-section of the contact tail, and the aperture may have a cross-section that is slightly smaller than the cross-section of the contact tail so that the insulative disk may form a moisture-resistant seal that may reduce or prevent ingress of water or moisture that may migrate through the connector port into the interior of the housing of the RF subscriber drop unit.

In some embodiments, one or more of the connector ports on the RF subscriber drop units according to embodiments of the present invention may comprise “integrated” compression style connector ports that are configured to have a coaxial cable compression terminated therein. Integrated compression style connector ports are known in the art and have been used with RF subscriber drop equipment. An example integrated compression style connector port is disclosed in U.S. Patent Publication No. 2013/0157507, assigned to the assignee of the present application. The use of integrated compression style connectors may have several advantages, including making it more difficult for unauthorized users to access the RF subscriber drop unit and eliminating the problem of F-style coaxial connectors that are not sufficiently tightened onto their mating female connector port (which can result in signal loss, loss of the ground plane connection, ingress of unwanted RF interference, etc.). In such embodiments, the conductive spark gap unit may, for example, be interposed between the contact assembly and the housing of the RF subscriber drop unit so as to be in electrical contact with the housing.

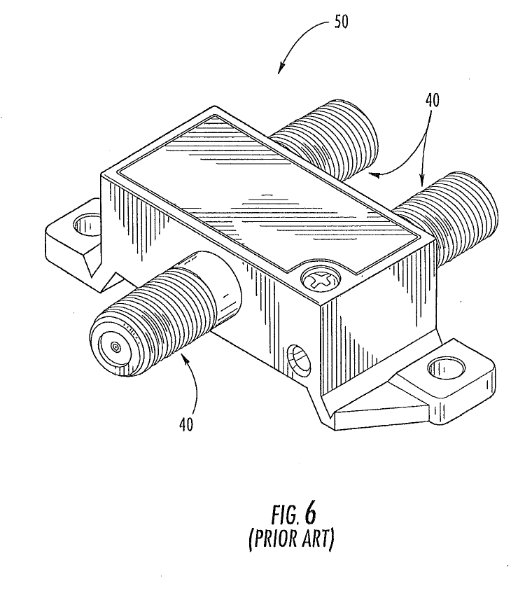

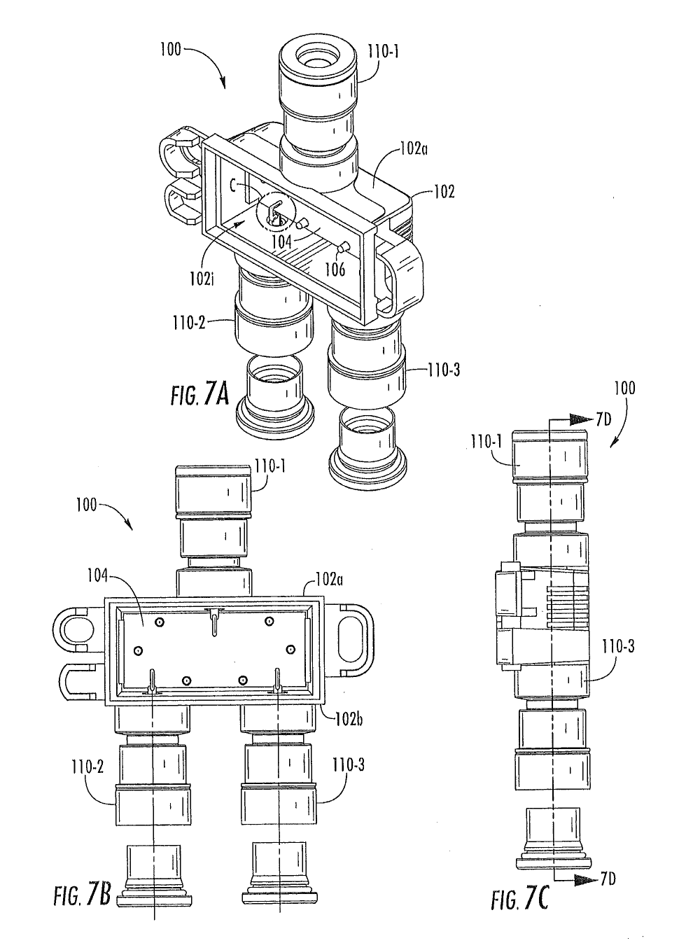

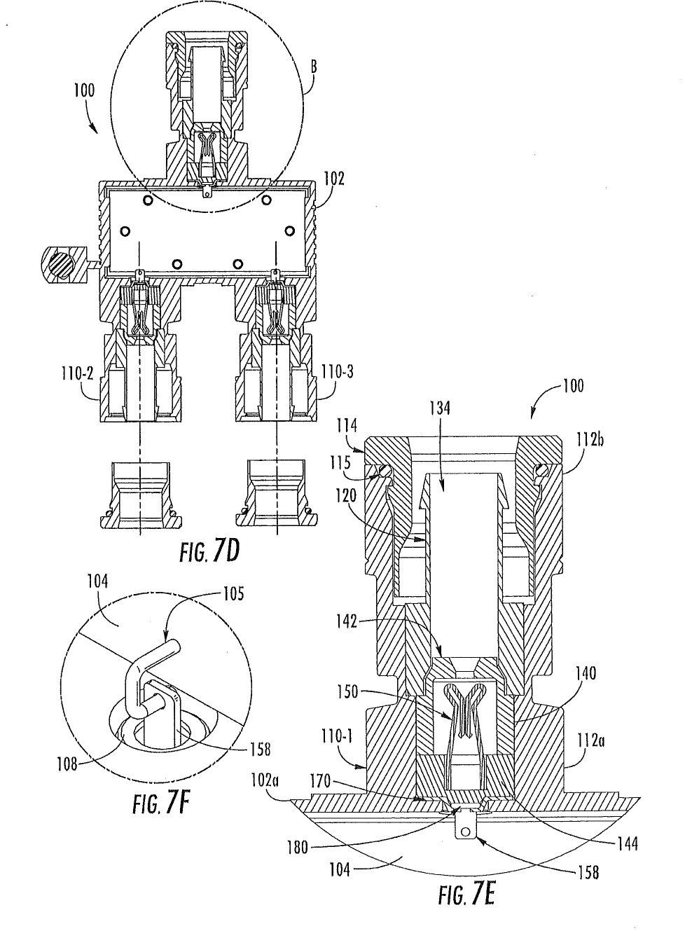

Embodiments of the present invention will now be described in greater detail with respect to FIGS. 7-10, in which example embodiments of the invention are shown.

An RF subscriber drop unit 100 according to a first embodiment of the present invention is illustrated in FIGS. 7-9. In particular, FIG. 7A is a perspective view of the RF subscriber drop unit 100 with a cover plate thereof removed to reveal the interior of the unit. FIGS. 7B and 7C are a bottom view and a side view, respectively, of the RF subscriber drop unit 100 (with the cover omitted). FIG. 7D is a cross-sectional view of the RF subscriber drop unit 100 taken along the line 7D-7D of FIG. 7C. FIG. 7E is an enlarged view of the portion of the cross-sectional view of FIG. 7D that is within the call-out labeled B in FIG. 7D. FIG. 7F is an enlarged view of the callout labeled C in FIG. 7A.

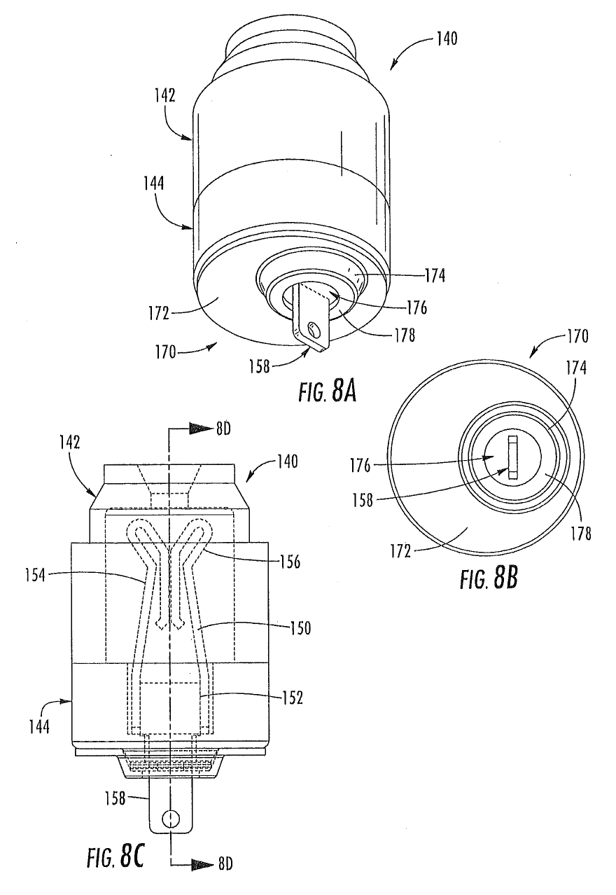

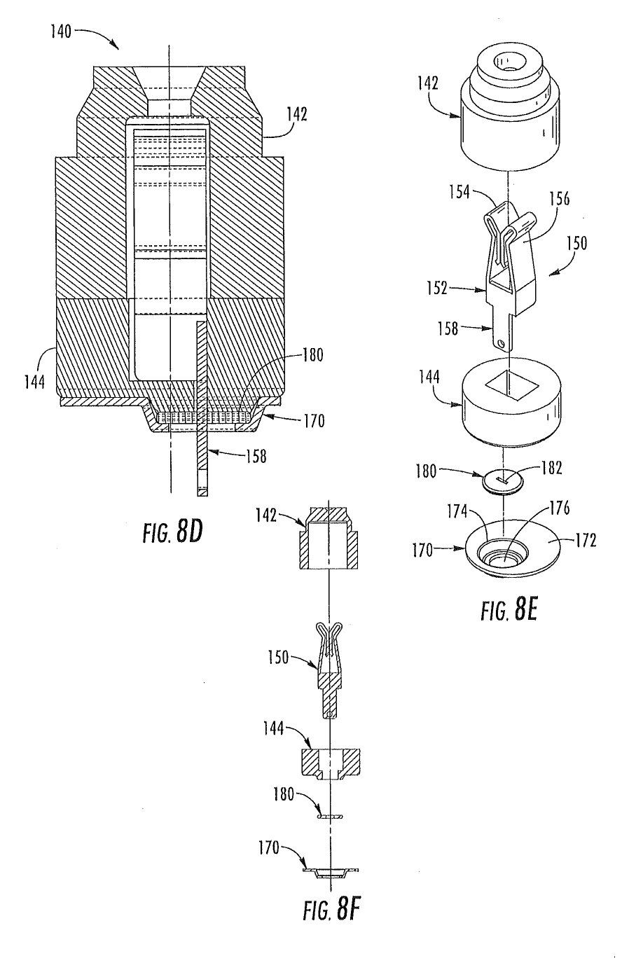

FIGS. 8A-8F illustrate a contact assembly that is included in each of the connector ports of the RF subscriber drop unit of FIGS. 7A-7E. In particular, FIG. 8A is a perspective view of the contact assembly. FIG. 8B is an end view of the contact assembly. FIG. 8C is a top view of the contact assembly that illustrates the position of the spring contact within the contact assembly using dotted lines. FIG. 8D is a cross-sectional view of the contact assembly taken along the line 8D-8D of FIG. 8C. FIG. 8E is an exploded perspective view of the contact assembly that illustrates how the individual components thereof may be put together to form the contact assembly. FIG. 8F is an exploded, cross-sectional view of the contact assembly of FIG. 8A.

As shown in FIGS. 7A-7D, the RF subscriber drop unit 100 has a housing 102 with opposite first and second sides 102a, 102b. As noted above, a cover piece of the housing is removed to illustrate the interior 102i thereof. A printed circuit board 104 (FIGS. 7A-7B) is mounted within the interior 102i of housing 102 on a plurality of posts 106 that extend downwardly from the inner surface of the top wall of the housing. Circuitry (not shown) is provided on the printed circuit board 104.

An input connector port 110-1 extends from side 102a of housing 102, and a pair of output connector ports 110-2, 110-3 extend from side 102b of housing 102. The above-mentioned circuitry on the printed circuit board 104 electrically connects connector port 110-1 with connector ports 110-2, 110-3. The printed circuit board 104 performs various functions (depending on the type of device) as would be known to one skilled in the art. Each connector port 110 is configured to be electrically and mechanically attached to a prepared end of a respective coaxial cable.

As shown best in FIG. 7E, each connector port 110 has a tubular connector body 112 having a base 112a and an opposite distal end 112b. The connector body 112 of each connector port 110 may be formed integrally with the housing 102. The housing 102 including the connector bodies 112 may be formed of a conductive metal such as, for example, brass, steel, or bronze, or alloys thereof or another metal or metal alloy. The inner and/or outer diameters of the connector body 112 may vary along the length of the connector body 112.

The connector port 110 also includes a compression element 114 that is coupled to the distal end 112b of the connector body 112. The compression element 114 is configured to move between an unseated position and a seated position (shown in its seated position in FIG. 7E). The compression element 114 is configured to impart a compressive force to secure one or more elements of a coaxial cable within the connector body 112 when the compression element 114 is in the seated position. As shown in FIGS. 7A-7B, the compression element 114 may be detachable from the connector body 112 to allow an installer a better view of the interior of the connector port 110 when a coaxial cable 10 is installed into the connector port 110.

The connector port 110 further includes a tubular, open-ended inner contact post 120 that is positioned within the connector body 112. The contact post 120 has an axial bore 134 that is open at either end thereof. An installer may insert the central conductor 12, dielectric insulator, 14 and tape 16 of a coaxial cable 10 within the contact post 120. The electrical shield 18 of the coaxial cable 10 may be inserted to concentrically surround the contact post 120 (the end portion of the jacket 20 may be at least partially removed). The outside surface of the distal end of the contact post 120 may include one or more serrations, teeth, lips or other structures 122. The contact post 120 is typically formed of a conductive material such as, for example, brass, steel, or bronze, or alloys thereof.

The compression element 114 may comprise a hollow cylindrical body that may be permanently or detachably attached to the connector body 112. The compression element 114 is typically formed of a non-conductive, plastic material, but may also be formed of other materials. In some embodiments, the portion of the compression element 114 that is received within the connector body 112 may have a first external diameter that is less than a second external diameter of the opposite end of the compression element 114. A gasket or O-ring 115 may be mounted on the exterior surface of the compression element 114. As shown best in FIG. 7E, the inner diameter of the end of the compression element 114 that is received within the connector body 112 may be greater than the inner diameter of the opposite end of the compression element 114. A ramped transition section may connect these inner radii. While the compression element is depicted as an “internal” compression element in the embodiment of FIG. 7, it will be appreciated that in other embodiments an “external” compression element may be used that fits over the outside surface of the connector body 112.

The compression element 114 is closer to the apparatus housing 102 when in the seated position than when in the unseated position. In addition, the compression element 114 is positioned between the connector body 112 and the contact post 120 when in the seated position. The outer surface of the compression element 114 may include a groove therein (not shown) that is configured to receive a gripping element of a compression tool that is used to move the compression element 114 from the unseated position to the seated position.

Still referring to FIG. 7E, the connector 110 includes a contact assembly 140 that is positioned within the connector body 112 between the base of the contact post 120 and the side wall 102a or 102b of the housing 102. The contact assembly 140 mounts a spring contact 150 within the connector port 110. The spring contact 150 receives and makes electrical contact with a center conductor 12 of a coaxial cable 10 that is terminated into connector port 110 in order to electrically connect the center conductor 12 to circuitry on the printed circuit board 104.

Turning now to FIGS. 8A-8E, the contact assembly 140 and spring contact 150 are illustrated in greater detail. As shown in FIGS. 8A-8E, the contact assembly includes an upper insulative housing 142 and a lower insulative housing 144 that is mounted adjacent to the upper insulative housing 142. Each of the upper insulative housing 142 and the lower insulative housing 144 have respective bores therethrough. The spring contact 150 is received within these bores.

The spring contact 150 has a base 152 and a pair of cantilevered arms 154, 156 that extend forwardly from the base 152. Each of the cantilevered arms 154, 156 is flared at its distal end and then is folded back on itself. The folded back sections of the cantilevered arms 154, 156 may contact each other. The center conductor 12 of a coaxial cable 10 that mates with connector port 110 may be received between the flared portions of the cantilevered arms 154, 156. A contact tail 158 extends rearwardly from the base so as to extend through the lower insulative housing 144. The contact tail 158 comprises the portion of the spring contact 150 that is opposite a spring contact portion 154, 156 that engages the center conductor of a mating coaxial cable. The contact tail 158 also comprises the portion of the spring contact 150 that extends from the connector port 110 into the interior 102i of the housing 102 of the RF subscriber drop unit 100.

The spring contact 150 may have various shapes and configurations. The spring contact 150 may be formed as an integral piece and may be formed of a conductive metal such as, for example, brass, steel or bronze or alloys thereof or another metal or metal alloy. In some embodiments, the spring contact 150 may be formed of a resilient metal such as beryllium copper or phosphor bronze.

A conductive spark gap unit 170 is also provided as part of the contact assembly 140. The conductive spark gap unit 170 in the illustrated embodiment comprises a metal disk 172 that has a hollow protrusion 174 extending from a front surface thereof. A spark gap aperture 176 is provided at the distal end of the hollow protrusion 174. A moisture seal 180 in the form of, for example, an insulating disk 180 may be positioned within the hollow protrusion 174. In some embodiments, the hollow protrusion 174 may take the form of a truncated frusto-conical protrusion that projects from a surface of the metal disk 172. The insulating disk 180 may have an aperture 182 through a central portion thereof. The aperture 182 may have a cross-sectional shape that matches the cross-sectional shape of the contact tail 158 and that is slightly smaller than the cross-section of the contact tail 158. The contact tail 158 may be inserted through the aperture 182 of insulating disk 180 and through the spark gap aperture 176 of the conductive spark gap unit 170. The insulating disk 180 may provide a moisture-resistant seal to prevent moisture that is received through the bores in the insulative housings 142, 144 from migrating through the aperture 176 in the conductive spark gap unit 170 into the interior 102i of housing 102.

The conductive spark gap unit 170 may act to discharge a high voltage that is passed from coaxial cable 10 to connector port 110 to ground. Such a high voltage may be injected onto the coaxial cable by, for example, a lightning strike. As shown in FIGS. 8A-8E, the contact tail 158 extends through the aperture 176 in the conductive spark gap unit 170. The contact tail 158 does not physically contact the conductive spark gap unit 170, but the four corners of the cross-section of the contact tail 158 may be in close proximity to the edge of the metal cap at the distal end of the hollow protrusion that defines the aperture 176.

For example, FIG. 9 is an enlarged bottom cross-sectional view of the contact assembly 140 taken across the aperture 176 in the conductive cap 178 at the bottom of the hollow protrusion 174. As shown in FIG. 9, the diameter of the aperture 176 determines the distance of the edges of the contact tail 158 from the conductive cap 178. The minimum distance between the edges of the contact tail 158 and the conductive cap 178 can be set so that, at a predetermined voltage level (e.g., voltages above approximately 50 volts), the current carried on the spring contact 150 will arc from the contact tail 158 to the conductive cap 178. It will be appreciated that the aperture 176 may be other than a circular cross-section and/or that the contact tail 158 may have other than a rectangular cross-section.

As shown, for example, in FIG. 7E, the conductive spark gap unit 170 is in physical and electrical contact with the housing 102. The housing 102 may be grounded to, for example, earth ground via a conventional grounding wire. As the current arcs to the spark gap ring it is carried to earth ground via the housing 102, thereby discharging the transient voltage spike so that it does not pass to the sensitive electronic circuits on the printed circuit board 104 which can be damaged or destroyed by such transient voltage spikes.

In the depicted embodiment, the contact tail 158 is closest to the conductive spark gap unit 170 at four separate points, which are at the corners labeled 179 in FIG. 9. Thus, when a transient high voltage spike passes through the contact tail 158, the current may tend to arc from the contact tail 150 to the conductive spark gap unit 170 at one of these four locations. When such a high current level arcs across a gap, it may damage the metal such that it may not support a current arc if another high voltage spike is passed to the contact tail 158. By providing four locations 179 where the contact tail 158 passes close to the conductive cap 179, the connector port 110 may be designed to survive at least four separate high voltage spikes.

The connector port 110 may be assembled by putting together the components of the contact assembly 140 in the manner shown in the exploded perspective view of FIG. 8E. The contact assembly 140 may then be inserted into the cavity defined by the connector body 112. The sidewall 102a of the housing 102 may have a circular port aperture 108 (see FIG. 7F) that mates with the hollow protrusion 174 of the conductive spark gap unit 170. The contact tail 158 may protrude through this port aperture 108 into the interior 102i of the housing 102. A wire or other contact structure 105 may electrically connect the contact tail 158 to the printed circuit board 104. The contact tail 158 may include an aperture and the wire 105 may be received within this aperture in the contact tail 158.

After the contact assembly 140 (including the conductive spark gap unit 170) is inserted into the interior of the connector body 112, the contact post 120 may then be inserted within the interior of the connector body 112 in order to lock the contact assembly 140 in place. As shown in FIG. 8E, the distal end of the upper insulator 142 of the contact assembly 140 is received within the base of the contact post 120. The contact post 120 may have a diameter that is slightly larger than the internal diameter of the portion of the cavity in the connector body 112 that receives the contact post 120 so that the contact post 120 is interference fit within the cavity. The contact post 120 presses the upper and lower insulators 142, 144 against the conductive spark gap unit 170, thereby forcing the conductive spark gap unit 170 against the exterior of the housing 102 to electrically connect the conductive spark gap ring 170 to the housing 102. In this fashion, the interference fit of the contact post 120 within the connector body 112 acts to hold the contact assembly 140 (including the conductive spark gap unit 170) in place within the connector body 112 and also acts to electrically connect the conductive spark gap unit 170 to ground through the housing 102.

As shown best in FIGS. 8A, 8B and 8E, the hollow protrusion 174 of the conductive spark gap unit 170 may not be located in the center of the metal disk 172, but instead may be offset to one side of the metal disk 172. The hollow protrusion 174 may be offset in this fashion in order to ensure that the contact tail 158 is oriented properly with respect to the printed circuit board 104. This arrangement may make it easier to solder the wire or other contact structure 105 to the printed circuit board 104. As shown in FIGS. 7E and 8A, each conductive spark gap unit 170 having the hollow protrusion 174 resides in the bottom potion of a respective one of the connector ports 110. The circular port apertures 108 through the sidewalls of the housing 102 may be offset from respective central axes of the connector ports 110 so that they are aligned with the offset hollow protrusions 174.

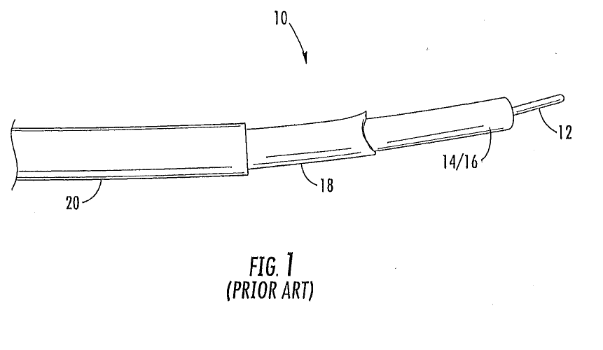

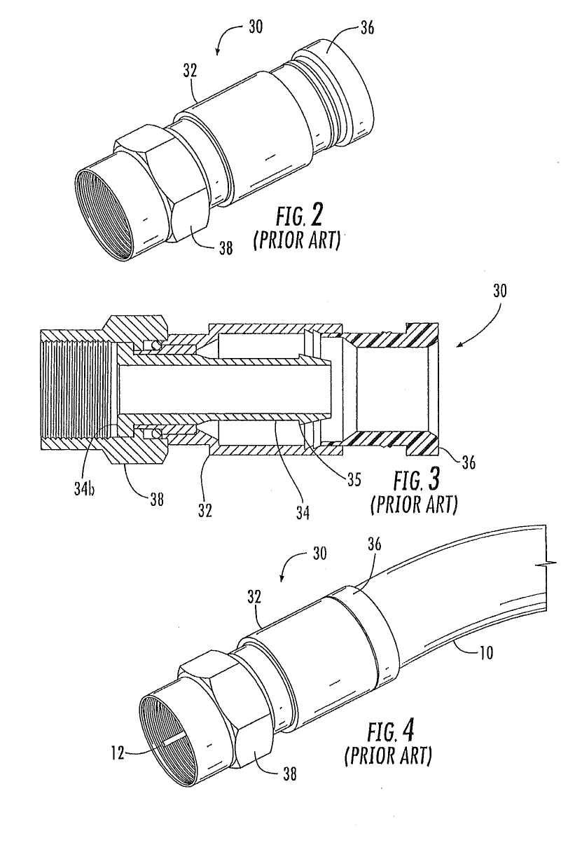

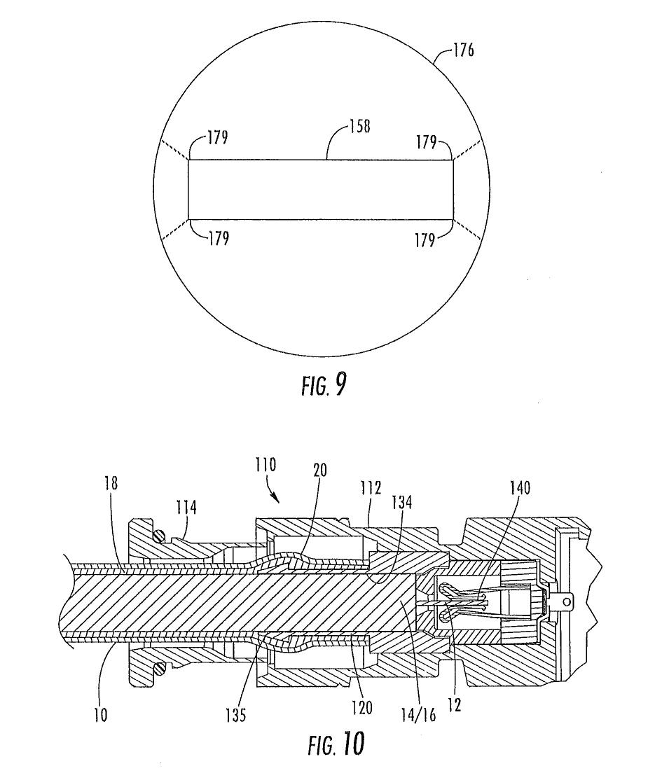

FIG. 10 is a section view of the RF subscriber drop unit 100 of FIGS. 7-8 illustrating how a coaxial cable 10 may be terminated into one of the connector ports 110 thereof. Before the cable 10 is inserted into the connector port 110, end portions of the dielectric 14, the tape 16, the electrical shield 18 and the cable jacket 20 are cut off and removed so that the end portion of the central conductor 12 is fully exposed, as described above with respect to FIG. 1. Additional end portions of the cable jacket 20 and any electrical shielding tape are then removed to expose an end portion of the wires of the electrical shield 18. Next, the central conductor 12, dielectric 14, and the tape 16 of cable 10 are axially inserted through the compression element 114 and into the axial bore of the contact post 120, while the exposed electrical shield 18 is inserted through the compression element 114 and over the outside surface of the contact post 120. The exposed length of the central conductor 12 is sufficient such that it will pass all the way through the connector body 112 and extend into contact assembly 140 where it is received between the cantilevered arms 154, 156 of the spring contact 150.

The exposed end portions of the wires of the electrical shield 18 reside in a front portion of the generally annular cavity between the contact post 120 and the connector body 112, thereby placing the electrical shield 18 in mechanical and electrical contact with at least one of the connector body 118 or the contact post 120. The center conductor 12 of the coaxial cable 10 is electrically connected to a circuit on the printed circuit board 104 via the spring contact 150, since the tail 158 of spring contact 150 extends into the interior of the housing 102i where it is electrically connected to the printed circuit board 104, as is shown in FIG. 7F. An installer then uses a compression tool to move the compression element 114 into its seated position after the coaxial cable 10 has been inserted into the connector body 112 to lock the coaxial cable 10 in place.

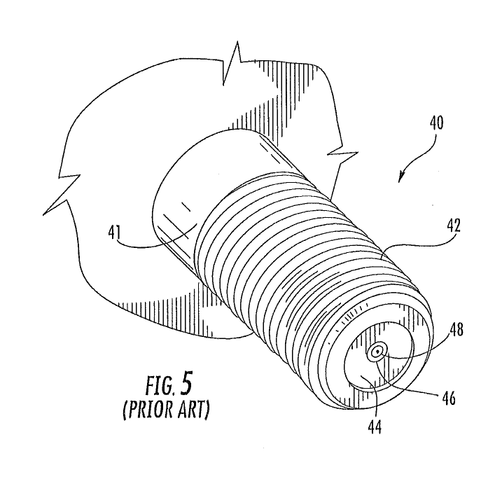

It will be appreciated that the connector ports 110 that are described above may be used on any appropriate RF subscriber drop unit including RF signal splitters, directional couplers, tap units, signal amplifiers, ground blocks, inline filters, signal conditioning units and the like. It will also be appreciated that the above-identified RF subscriber drop units may have any appropriate number of input and output ports (e.g., a 1×2 splitter, a 1×4 splitter, a 1×8 splitter, etc.). It will further be appreciated that some of the connector ports on a given RF subscriber drop unit may comprise connector ports according to embodiments of the present invention while other connector ports may comprise, for example, conventional female connector ports such as the female connector port depicted in FIG. 5.

In the above-described embodiment of the present invention, the conductive spark gap unit 170 is positioned around the contact tail 158 of spring contact 150. It will be appreciated, however, that in other embodiments, the conductive spark gap unit 170 may be positioned around other parts of the spring contact 150 such as, for example, the base 152 or the cantilevered arms 154, 156. It will also be appreciated that other spring contacts may be used that are designed differently than the spring contact 150 discussed above.

While in the above embodiments the conductive spark gap unit 170 is used on an “integrated” connector port in which the coaxial cable 10 is compression terminated directly into the connector port 110, it will be appreciated that in other embodiments the conductive spark gap unit 170 may be used on a standard externally threaded female connector port such as the connector port depicted in FIG. 5.

The conductive spark gap units according to embodiments of the present invention may provide a number of advantages over conventional spark gap structures. For example, many conventional spark gap units are implemented on a printed circuit board of an RF subscriber drop unit. While this may simplify the manufacture of the RF subscriber drop unit, such printed circuit board mounted or implemented spark gap units may be less likely to fully protect the RF subscriber drop unit from damage during high voltage spikes, and may not protect well against repeated high voltage spikes. Additionally, the conductive spark gap units according to embodiments of the present invention may exhibit high voltage spike limits, shorter assembly times and reduced costs compared to conventional spark gap units.

The present invention has been described above with reference to the accompanying figures, in which embodiments of the invention are shown. This invention may, however, be embodied in many different forms and should not be construed as limited to the embodiments set forth above. Those skilled in the art will readily appreciate that many modifications are possible to the exemplary embodiments described above that do not materially depart from the novel teachings and advantages of this invention. Accordingly, all such modifications are intended to be included within the scope of this invention as defined in the claims.

In the description above and in the accompanying figures, like numbers refer to like elements unless otherwise indicated. Certain components or features may be exaggerated in the figures for clarity.

It will be understood that in the above description when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment and/or figure, the features and elements so described or shown can apply to other embodiments and/or figures.

The terminology used in the present specification is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As used herein, the term “longitudinal” and derivatives thereof refer to the direction defined by the central axis of a coaxial connector, which is generally coexistent with the central axis of any coaxial cable that the coaxial connector is installed on when the coaxial cable is fully extended in a straight line. This direction may also be referred to herein as the “axial” direction.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention. Well-known functions or constructions may not be described in detail for brevity and/or clarity.

That which is claimed is:

1. An RF subscriber drop unit, comprising:
a housing having a port aperture therethrough;
a connector port extending outwardly from the housing and surrounding the port aperture, the connector port including a contact assembly that holds a spring contact, the spring contact including a contact tail that extends through the port aperture; and
a conductive spark gap unit that has a spark gap aperture, wherein the contact tail extends through the spark gap aperture.

2. The RE subscriber drop unit of claim 1, wherein the conductive spark gap unit comprises a conductive disk.

3. The RF subscriber drop unit of claim 2, wherein the conductive spark gap unit comprises a hollow protrusion that extends from a first side of the conductive disk, and wherein the spark gap aperture extends through the hollow protrusion.

4. The RF subscriber drop unit of claim 3, further comprising a moisture seal that has an aperture therethrough, the moisture seal at least partly positioned within the hollow protrusion.

5. The RF subscriber drop unit of claim 2, wherein the hollow protrusion comprises a truncated frusto-conical protrusion, and wherein the spark gap aperture extends from a second side of the conductive disk through a bottom portion of the truncated frusto-conical protrusion.

6. The RF subscriber drop unit of claim 1, wherein the contact tail extends through the port aperture to connect to a printed circuit board that is mounted in an interior of the housing.

7. The RF subscriber drop unit of claim 1, wherein the RF subscriber drop unit is configured to ground high voltage spikes by arcing a current from the contact tail to the conductive spark gap unit.

8. The RF subscriber drop unit of claim 1, wherein the connector port comprises a tubular connector body that has a base that extends outwardly from the housing and a distal end that is configured to receive a coaxial cable, a contact post that is within the connector body outwardly of the contact assembly, and a compression element that engages the distal end of the connector body, the compression element configured to move between an unseated position and a seated position and to impart a compressive force to secure one or more elements of the coaxial cable within the connector body when the compression element is in the seated position.

9. The RF subscriber drop unit of claim 1, wherein the moisture seal comprises an insulative seal that is positioned within the hollow protrusion, the insulative seal including an aperture that the contact tail extends through.

10. The RF subscriber drop unit of claim 1, wherein the RF subscriber drop unit comprises an RF signal splitter, an RF directional coupler or an RF signal amplifier.

11. A contact assembly for a connector port, comprising:
a spring contact that has a contact tail;
an insulative housing that at least partially surrounds the spring contact;
a conductive spark gap unit that includes a spark gap aperture; and
a moisture seal that surrounds the contact tail,
wherein the contact tail extends through the spark gap aperture.

12. The contact assembly of claim 11, wherein the conductive spark gap unit includes a hollow protrusion, and wherein the spark gap aperture extends through a bottom of the hollow protrusion.

13. The contact assembly of claim 12, wherein the hollow protrusion comprises a truncated frusto-conical protrusion.

14. The contact assembly of claim 11, wherein the moisture seal is positioned at least partially within the hollow protrusion.

15. The contact assembly of claim 11, wherein the moisture seal comprises an insulative disk having an aperture therethrough that receives the contact tail.

16. The contact assembly of claim 11, wherein the conductive spark gap unit comprises a conductive disk that includes a protrusion protruding therefrom.

17. The contact assembly of claim 16, wherein the conductive disk comprises a circular disk, and wherein the hollow protrusion is offset from a center of the circular disk.
